(19) United States
(12) Patent Application Publication
(10) Pub. No.: US 2021/0264496 A1
(43) Pub. Date: Aug. 26, 2021

(54) MACHINE LEARNING FOR RAPID ANALYSIS OF IMAGE DATA VIA CURATED CUSTOMER PERSONAS

(71) Applicant: GOLDENSPEAR LLC, San Francisco, CA (US)

(72) Inventors: Alejandro Claros, Barcelona (ES); Javier Castan, Barcelona (ES); Santos Moises Soto, San Francisco, CA (US); Mike Logan, Overland Park, KS (US)

(73) Assignee: GOLDENSPEAR LLC, San Francisco, CA (US)

(21) Appl. No.: 17/179,284

(22) Filed: Feb. 18, 2021

Related U.S. Application Data
(60) Provisional application No. 62/979,959, filed on Feb. 21, 2020.

(51) Int. Cl. G06Q 30/06; G06K 9/00; G06N 3/04; G06F 17/16

(52) U.S. Cl. CPC G06Q 30/0631; G06K 9/00295; G06F 17/16; G06K 9/00268; G06N 3/04; G06K 9/00255

(57) ABSTRACT

A system is disclosed that includes a video camera, a local image processing computer, a remote event detection server, and a remote data integration database. This technology utilizes deep learning and domain-specific customer personas to rapidly derive economically useful insights from real-time video imagery with an emphasis on personal fashion and lifestyle.

### PRIORITY CLAIM

The present application claims priority to U.S. Provisional Patent Application No. 62/979,959, filed on Feb. 21, 2020, entitled “MACHINE LEARNING FOR RAPID ANALYSIS OF IMAGE DATA VIA CURATED CUSTOMER PERSONAS,” which application is incorporated by reference herein in its entirety.

### BACKGROUND

With the emergence of eCommerce, global retailers are in a race to modernize the shopping experience. Historically on-line firms seek to play to their advantages, which include selection, convenience, and web-based analytics to overcome the high volume of returns, extreme comparison shopping, high-tech fraud, and the propensity of many customers to abandon purchases in the final stages. Similarly, historically store-based retailers seek to exploit their advantages of immediate gratification, merchandise interaction, and human relationships to counter eCommerce sales erosion, infrastructure costs, and inventory loss. Both are rapidly moving to integrate the best aspects of on-line and in-store shopping and over time these models will continue to converge, influenced by additional forces such as the rise of 5G networks and shifting population demographics. Tools that help integrate the on-line and in-store shopping experience will be central to realizing this transition.

Fueled by large on-line retailers like Amazon, retail analytics has become a significant global market segment, valued at $3 Billion in 2018 and expected to grow to over $8 billion by 2024. Typical products in the space might include chat bots for customer care, application of machine learning to Customer Relationship Management (CRM) data, machine vision for fraud prevention, and predictive ordering to minimize inventory costs.

### DESCRIPTION OF THE DRAWINGS

FIG. 1 illustrates a system within which augmented video profile feature vectors are generated according to embodiments of the present technology.

FIG. 2 is a graph of fashion features plotted against demographic features for the mapping of feature vectors according to embodiments of the present technology.

FIG. 3 illustrates the definition of an initial set of personas based on feature mapping according to embodiments of the present technology.

FIG. 4 is a flow illustrating the mapping of feature vectors to most-similar persona groups according to embodiments of the present technology.

FIG. 5 is a chart of thresholding values estimating affinity of five visitor-derived feature vectors to each pre-defined persona group according to embodiments of the present technology.

FIG. 6 is a flow of an iterative process for mapping feature vectors to persona groups based on on-line interaction with a web site rather than direct in-store observation according to embodiments of the present technology.

FIG. 7 illustrates the mapping of a visitor-derived feature vector to existing root personas in reduced-dimensional space according to embodiments of the present technology.

FIG. 8 illustrates generation of a new persona group upon repeated appearance of visitor-derived feature vectors according to embodiments of the present technology.

FIG. 9 illustrates modules of the In-store Video Subsystem according to embodiments of the present technology.

FIG. 10 is a flow of information through the Person Matching and Profiling Service according to embodiments of the present technology.

FIG. 11 illustrates a convolutional neural network for detecting the presence of a person with multiple separate body and face crops according to embodiments of the present technology.

FIG. 12 illustrates a convolutional neural network for feature extraction based on an uncropped image capture according to embodiments of the present technology.

FIG. 13 illustrates a series of convolutional neural networks for formulating feature vectors using face crops according to embodiments of the present technology.

FIG. 14 illustrates a series of convolutional neural networks for formulating feature vectors using body crops according to embodiments of the present technology.

FIG. 15 illustrates a convolutional neural network for analyzing individual fashion products according to embodiments of the present technology.

FIG. 16 illustrates a shopper derived from actual in-store video imagery as the visitor enters a retail store.

FIG. 17 illustrates a feature vector associated with shopper using updated image data according to embodiments of the present technology.

FIG. 18 illustrates a feature vector of a celebrity influencer according to embodiments of the present technology.

FIG. 19 illustrates a list of similarity scores between a shopper represented by the vector in FIG. 17 and various celebrity influencer personas according to embodiments of the present technology.

### DETAILED DESCRIPTION

The present technology will now be described with reference to the figures, which in general relate to the generation of personal trait feature vectors using cameras or other sensors to sense physical attributes of one or more people. The feature vectors may then be analyzed using artificial intelligence algorithms to both define persona groups within which different feature vectors fit, as well as to match a given feature vector in real-time to the plurality of economically-significant personas that they most closely resemble.

A persona group, or simply persona, is a fictional character or characters created to represent a user type that might use a site, brand, or product in a similar way. Marketers may use personas together with market segmentation, where the qualitative personas are constructed to be representative of specific segments. The present technology uses personas rather than uniquely-identifying user accounts to derive useful insights from the feature vectors created by the in-store sensors and a Person Matching and Profiling Service as explained below. These personas are usually defined based on a clustering of actual profile data derived from the Person Matching and Profiling Service over time and will likely be enriched to reflect revenue targets for this subset of customers and products likely to appeal to them.

It is understood that the present technology may be embodied in many different forms and should not be construed as being limited to the embodiments set forth herein. Rather, these embodiments are provided so that this disclosure will be thorough and complete and will fully convey the technology to those skilled in the art. Indeed, the technology is intended to cover alternatives, modifications and equivalents of these embodiments, which are included within the scope and spirit of the technology as defined by the appended claims. Furthermore, in the following detailed description of the present technology, numerous specific details are set forth in order to provide a thorough understanding of the present technology. However, it will be clear to those of ordinary skill in the art that the present technology may be practiced without such specific details.

Augmented Video Profile Feature Vector Generation

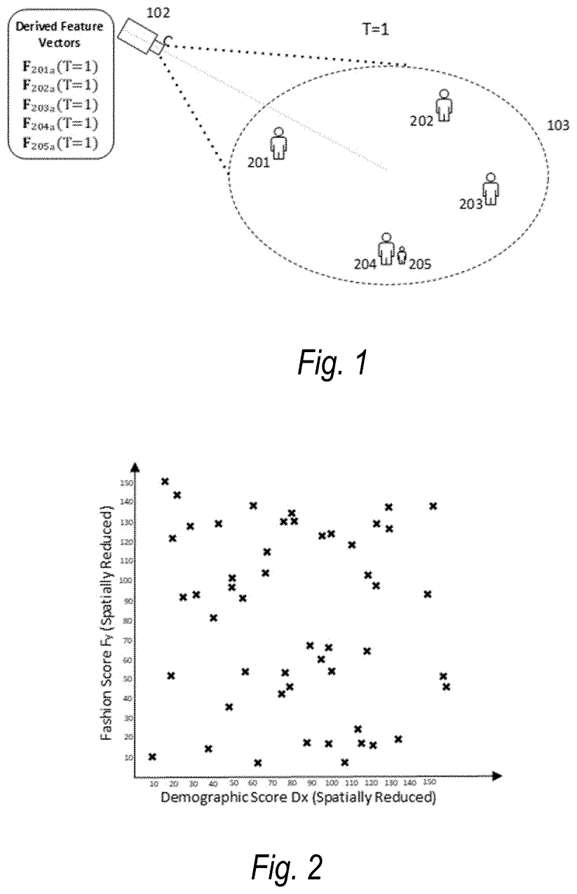

The augmented video profile feature vector (or simply feature vector) will now be explained with reference to FIG. 1. The feature vector, Fya, in one embodiment is based on imagery extracted from one or more multi-role video cameras 102 installed so as to fully cover an area 103 of interest. That is, all entrances and exits to and from the area of interest benefit from video coverage and each guest (e.g., 201, 202, 203, 204, 205) is assumed visible on one or more cameras 102 for the duration of their visit. This data stream is then sampled and then analyzed to produce the best possible view of a given customer and this imagery is then subjected to various machine vision techniques to extract details of relevance to the given domain. Typical video processing might include background elimination, coarse object definition (“blob” detection), object tracking, multiframe fine object recognition, inference model application, and then vector augmentation. The more detail that can be extracted from the imagery, the longer the resulting feature vector will become. A feature vector may be developed for each person within the area at a given time. Thus, in the example of FIG. 1, at time T=1, there are five people (201-205) in area 103, and a feature vector F₂₀₁ₐ-F₂₀₅ₐ is developed and stored for each person.

Common implementations of machine vision might focus on facial recognition for security applications, or time-and-space motion tracking for industrial applications. For the present technology, at least 3 distinct domains of machine vision are applied simultaneously to develop the augment version of the feature vectors Fya. In embodiments, these are:

Facial Recognition: In general, these algorithms operate by measuring distinctive attributes about a subject's face, such as relative size, shape and relative orientation of key facial features. These algorithms can be sub-divided into geometric approaches that focus on distinguishing characteristics or photometric approaches which distill the image into a set of distinguishing metrics. This approach uses photometrics to create a vector of measurements as well as a composite metric referred to as the faceID used to identify the record on an ongoing basis. Vectors with a very similar faceID will have many facial characteristics in common and so will likely be of the same person.

Fashion Feature Extraction: In contrast to other machine vision approaches, the present disclosure augments facial information with precise observations about the subject's style and grooming preferences. These details are extracted by fine feature detectors and then subjected to one or more deep learning algorithms trained to identify various items of clothing at varying level of specificity based on resolution down to the type (brown pants), cut (boot-cut, athletic cut, etc.), and brand (Dockers, Gap, etc.). This deep learning is structured based on a multi-tier hierarchical data model created for this technology referred to as the fashion genome, with an extensive library of imagery for each distinction allowing for progressively more detailed disclosures about an object based on available resolution (i.e. from “brown pants” to “athletic cut Dockers in Signature Khaki”). This genomic model is extended to include key grooming attributes such as hair style, luxury accessories, team logos, and body markings. Each isolated observation is appended to the feature vector as a distinguishing attribute of that visitor.

Demographic Categorization: Other machine vision techniques can be applied to assign other distinguishing attributes to the visitor, such as height, gender, age-range, and skin tone. These can be estimated using deep learning based on libraries of reference imagery or by real-time comparison with known objects in a scene (say, a person walking by a display of known height to precisely estimate the height of the visitor). By taking fashion features into consideration a general assessment of the visitor fashion aesthetic can be developed—say “urban minimalist,” “athletic casual,” “business formal.” Similar to Fashion features, the level of detail will vary by resolution, with all successfully measured features added to the resulting feature vector and referenced by faceID.

This multifaceted analysis will be conducted recursively as long the visit continues with additional observations added and previous features amended based on improved data. Metadata such as arrival time, departure time, and dwell time in certain locations may able added to the augmented feature vector.

Persona-Based Empirical Data

Data-driven customer personas will be utilized to derive valuable insights from the augmented feature vectors associated with actual human visitors.

A “persona” as used herein can be described as a fictional character defined in substantive detail to assist with the holistic design of a product or service encompassing multiple domains of human concern. A conventional application of user personas might be in software product development, where the framing of the multiple concerns representative of a typical user has been shown to greatly improve the usability of resulting products. A long-standing issue regarding the applicability of personas is that they don't represent “actual customers” and so have limited applicability to sustaining operations like sales and marketing. This is underscored by the fact that the “demographics” associated with most personas is loosely assumed in order to establish consistency with the practical attributes like the persona's motivation to purchase a new product, their specific goals, and assumed relevant competency. Actual insight into the true demographics of the broad user base is generally limited to focus groups or self-reported surveys.

In the context of machine vision, the actual demographics of customers can be directly observed, and their goals can be strongly inferred by their shopping activity within the store or venue. It is their motivations and competencies that must be approximated, but this challenge can be mitigated to a large extent by the intrinsic motivations that draw all humans from time to time to the fashion marketplace. Further, retail stores themselves will reliably draw in customers within a given proximity to the store, and so that group will reflect a subset of the demographics of the local community. In this context, then, personas provide a powerful yet efficient means of extracting economically useful insights with a minimum of privacy concerns.

Consider the situation of FIG. 2, where 50 feature vectors representing actual measurements from in-store video are spatially reduced to a 2-dimensional coordinate system. That is, the 500+ potential fashion features are combined into a single numeric “score” according to a weighting algorithm represented on the y axis, while a separate single score based on 500+ demographic features is represented on the x-axis. A representation of these highly dimensional feature vectors can then be plotted in a conventional 2D coordinate system for high-level analysis. Note that this two-dimensional reduction is primarily for purposes of illustration and the technology in general makes use of higher-dimensional analysis to compare the similarity of feature vectors.

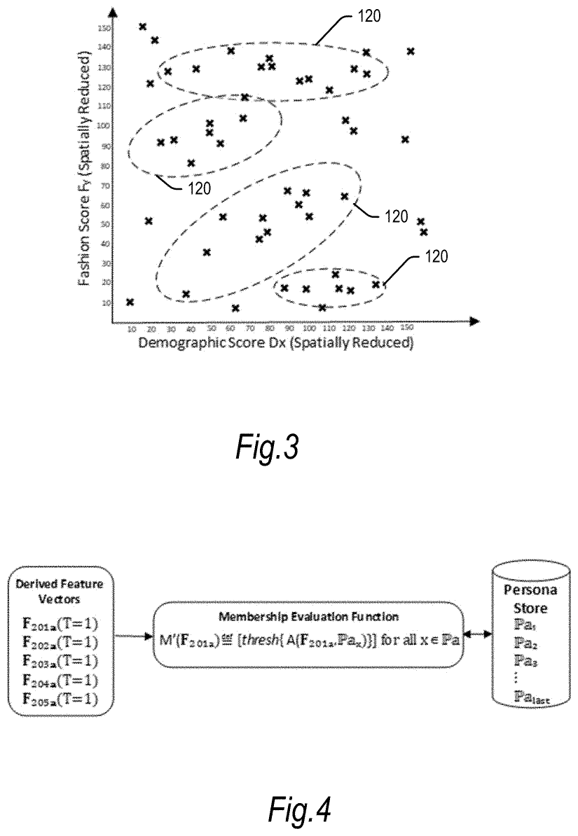

This sort of rich, high-dimension data is well suited for application of deep learning algorithms to discover underlying structural relationships, especially when further enriched by primary marketing research and sales history associated with known sets of visitors. Based on one or more iterations of analysis, an initial set of “customer personas” 120 can be defined, as illustrated in FIG. 3.

These initial customer personas 120, then, can be readily quantified in n-dimensional space as a hybrid of the actual customer profiles they encompass, further enriched with information such as historical sales loosely associated with this group and store merchandise that is intended to appeal to this customer base. Four personas 120 are shown here for purposes of illustration, but the actual number would be larger in practice. The quantity would still be much smaller, however, than other competing approaches that might be focused on uniquely associating each customer to a complex profile with data such as their loyalty account ID. Persona-based analysis is therefore faster and much more compliant with emerging privacy regulations.

The above example focuses on persona groups specific to known customer visitors, but this model also readily allows for incorporation of other personas, say celebrity influencers known to have a significant association with the particular market segment. This could include celebrities directly engaged by the brand to serve as a spokesperson or non-engaged celebrities known to have significant influence on fashion trends more generally. Further, a persona 120 can be defined that is referenced to a target persona that the establishment wants to attract over time. This influence can be incorporated in persona-base image analysis by simply defining a new enriched feature vector based on imagery of the celebrity influencer, spokesperson, or fashion trend of interest.

With an initial set of personas defined, persona-based image analysis can then be conducted by the repeated execution of an Affinity function A(Fya,Paₓ), measuring how closely the observed feature matrix aligns with the representative feature vectors designating the persona 120. This is repeated for all of the personas for each visitor, and basic thresholding is applied as shown in FIG. 4. The result is a set of personas that most closely align with that individual's expressed demographics and fashion characteristics.

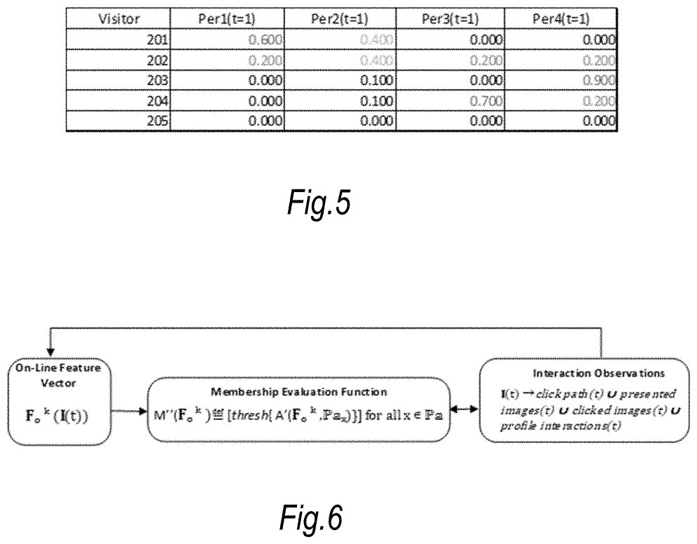

This approach elegantly allows for multiple distinct outcomes based on many factors, including the availability of camera imagery, the brand's relationship with the visitor, and of course, the customer's own sense of style and fashion. Several possibilities are illustrated in FIG. 5. Visitor 201, per this example, demonstrates an affinity to two personas, Pa1 and Pa2. The fit is not strong for either persona, though, so this type of result might be consistent with a local visitor who is new to the store. Visitor 202 demonstrates characteristics of multiple personas to a low level and so might be useful, if recurring, to trigger the definition of a new persona group more uniquely suitable to them. Visitor 203 strongly aligns Pa4 and might be consistent with a frequent visitor. At the extreme, a very customized persona can be defined say for a VIP that will strongly signal the presence of that individual in the store when appropriate. Visitor 205 is assessed to be a child and so the data is nulled out. Note that an objective of this present solution would be to always show multiple personas for a given customer, as this will add variety and engagement to the shopping experience.

An iterative version of this technology can further be applied to fashion consulting on-line, as show in FIG. 6. In this version of the technology, an image of the shopper is of course not available. In this situation, the customer's loyalty account information serves as a proxy and may be expanded over time to include a summary version of a feature vector based on customer opt-in. Machine vision techniques are then applied to the images that are presented to the customer during their browsing session as well as to the click path taken by the customer to reach a given destination to assess their likely interests. Just as personas are tied to inventory, searches of inventory items can be used to identify specifically related personas. The procedure is iterative since, as the customer views more imagery, the intersection of complementary personas can be progressively narrowed. This persona set can then be used as an online fashion consultant to make product suggestions or as an input to complex search algorithms.

Similar to the in-store feature vector, the on-line feature vector may include features from a customer's loyalty account and will continue to be augmented throughout the shopping session. The output of the “Membership function M” will still be a set of Personas satisfying a minimum threshold of alignment with the on-line feature vector Fₒ.

Curated Persona Sets

The third aspect of this present technology is referred to as automated curation of personas. In this phase, the defined persona groups are regularly reviewed by various machine learning algorithms with the objective of improving the alignment of the persona vectors themselves with the data derived from actual visitors. This process can involve the definition of new personas, updates to existing personas, or deletion of personas that contributed significantly to clustering errors. Personas may also be regularly added corresponding to new trends or influencers drawing significant attention and that might impact near-term purchasing decisions.

Technical intuition suggests that the effectiveness of this persona-based Machine Vision solution hinges on definition of personas that in some quantifiable sense reflect the shopping and purchasing habits of actual customers. Indeed, this relationship can become tenuous depending on the specific market of interest. Fortunately, fashion and style are forms of individual self-expression deeply rooted in human nature with established patterns of stylistic evolution that are also well understood and often driven by the industry itself. That make this marketplace particularly amenable to application of Machine Learning techniques to predict economic outcomes even at the transactional level. The personas themselves, though, will need to evolve with changes in demographics, sought-after styles, and seasonal merchandise in order to maintain and ideally improve the performance of the technology over time.

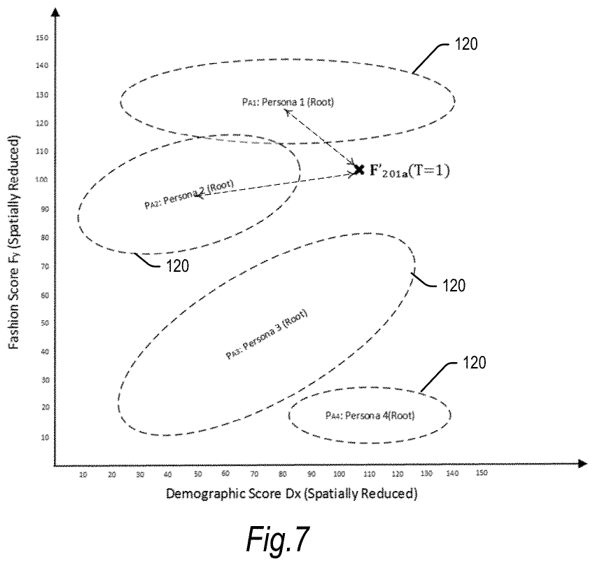

Consider the situation of FIG. 7, where the four previously-defined persona groups 120 have now been numbered and defined as “root” personas. These definitions are now being applied to the process of making product recommendations and assessing sales opportunity within a given store. The feature vector of Visitor 201 is shown plotted in this spatially-reduced coordinate system. The proximity of this feature vector to Personas Pa1 and Pa2 provide intuitive support to the assessment of the affinity scores assigned to Visitor 201 in FIG. 5. As suggested previously, the “fit” of this visitor to the defined persona groups is not strong and so the success of the resulting fashion recommendations and corresponding sales transactions are expected to be commensurately unpredictable. This type of result is not unexpected and this technology is specifically formulated to provide some level of support for all types of visitors with varying levels of confidence.

As part of the persona curation phase of the current technology, the errors associated with affinity mapping for all of the observed feature vectors over some time period will be aggregated and alternative configurations of the personas consider that would reduce this error score to a local minimum while also constraining the extent of the changes introduced by each iteration. In the case of FIG. 7, the single appearance of F201a in itself may not contribute significantly to accumulated affinity mapping error. However, if multiple visitors are detected with very similar attributes as F201a then the resulting error will quickly become significant. This will eventually reach a threshold where unsupervised learning techniques will recommend changes to the current persona definitions to better suit the observed data.

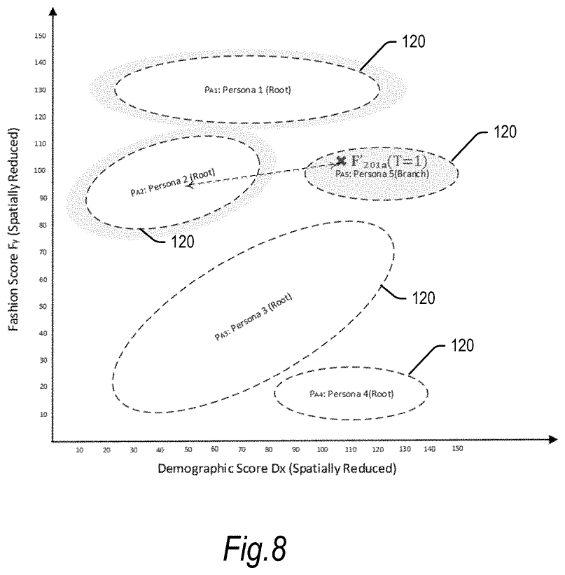

The revised persona definitions driven by repeated appearances of F201a are shown in FIG. 8. Note that a new persona has been defined—Pa5—and this has been dubbed a “branch” persona, as it has augmented but not replaced any of the original root personas. Two of the root personas themselves have been refined to represent smaller ranges of potential scores and to minimize conflicting affinities with customers strongly mapping to the new Pa5.

Machine learning-based persona curation will continue as a background process on a regular basis, but the results of this remapping as implemented in the current technology will be restricted to administrative logs until certain thresholds of performance improvement are fulfilled. At this point the persona curation module will recommend an update to the operational personas being used for machine vision along with an estimated improvement in the results. It will then be up to the human operators to approve these updates in whole or in part for use in active machine vision assessments of customer interests. Test personas are also supported by the current technology which can be run on limited sets of historical feature vectors to assess the performance of alternate root and branch personas.

Note that a version of the on-line affinity assessment procedure shown in FIG. 6 can be readily adapted to assist with curation of more creative personas associated with known fashion trends or influencers. Social media streams sponsored by these influencers can be subjected to feature extraction algorithms similar to those used on in-store imagery to identify the latest styles being adopted by that persona. Unlike customer-based root personas, these creative personas can be expected to change quickly with time to reflect various fashion movements. If a customer specifically wants to incrementally move toward a current fashion trend, then the in-store assistants will be able to assist regardless of their own personal familiarity or experience with popular culture relevant to the brand.

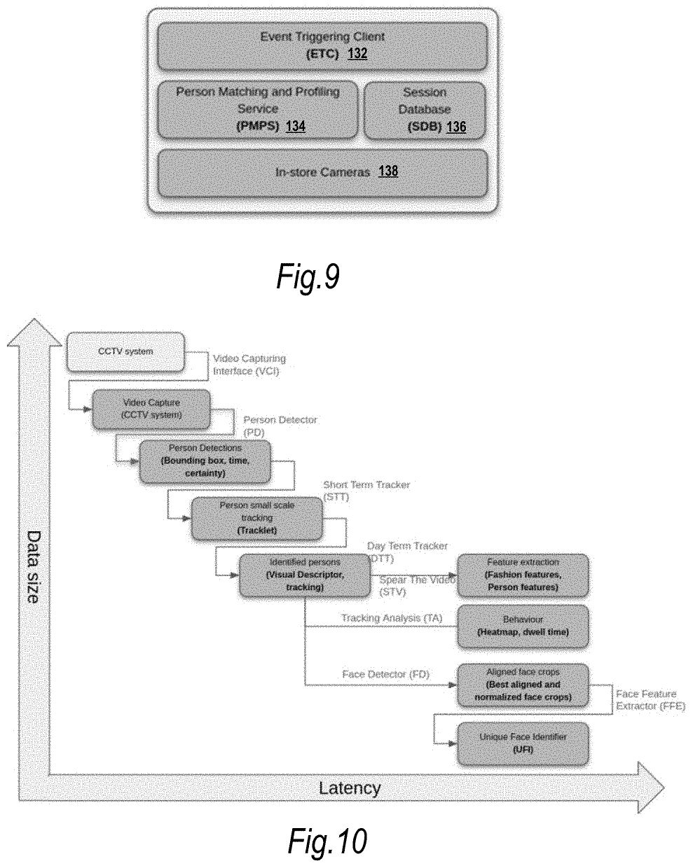

In one exemplary implementation, detailed marketing information is derived from video and imagery analysis utilizing a collection of elements on the customer premise, collectively referred to as the In-Store Video Subsystem. The modules comprising the In-store Video Subsystem are shown in FIG. 9. A description of each element follows.

Retail Video Feed. The video output from the premise Closed-Circuit Television (CCTV) system or in-store cameras. This usually involves multiple cameras 138 and a local recording solution with an API for retrieval of recorded imagery associated with each CCTV camera.

Person Matching and Profiling Service (PMPS). The Person Matching and Profiling Service 134 employs multiple image processing and deep learning modules to generate value-added feature vectors based on imagery extracted from the Retail Video Feed. The detailed image processing and deep learning modules comprising the PMPS are detailed below.

Session Database (SDB). The Session Database 136 stores the data generated by each module of the PMPS and provides an interface for querying and updating it. The SDB data is only kept during the period of a session (e.g., a day), being completely erased once the session is completely processed and the relevant information is sent by an Event Triggering Client to cloud-based storage.

Event Triggering Client (ETC). The Event Triggering Client 132 extracts from the SDB the finalized information vectors generated by the PMPS and updates centralized profiles on cloud-based servers.

A portion of the innovative practices disclosed in this present technology are centralized within the PMPS. The general flow of information through the PMPS is illustrated in FIG. 10, with the SDM providing persistent storage for handoff of intermediate data products between modules. Given the large volume of data generated by conventional CCTV systems, the PMPS incorporates several steps of data aggregation in order to manage computational load and exploit the innate spatial and temporal coherence of video feeds.

The function of each module in this exemplary implementation is described below.

Video Capture Interface (VCI). The VCI provides an interface to capture input feeds from several sources including:
Local CCTV systems
IP cameras
USB cameras
Camera management servers

This subsystem captures frames from the In-Store Cameras at a certain frame rate, processes it (scale, color normalization, etc.) and generates a processed frame in a structure [frame RGB image, frame_id, camera_id, timestamp].

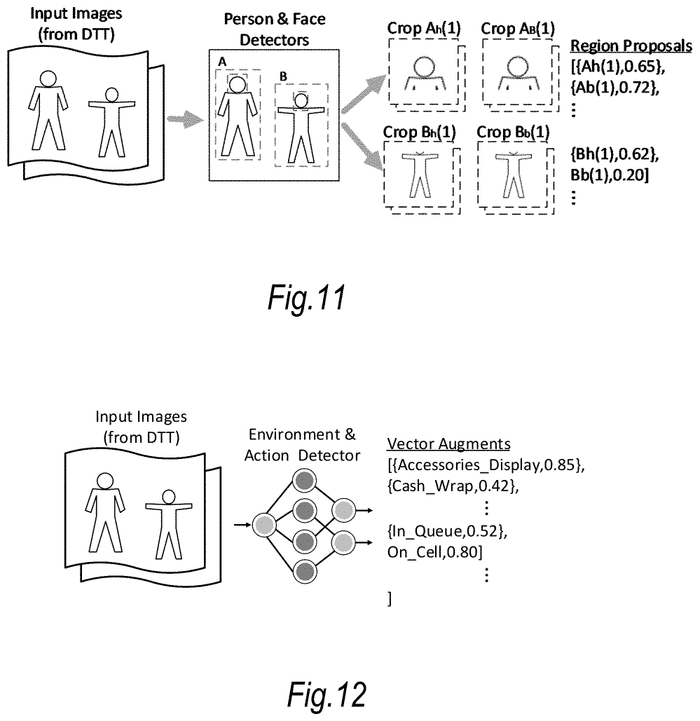

Person Detector (PD). The PD detects the presence of a person or multiple people within the video frames forwarded by the VCI and generates an image crop for each of the detected visitors. This process is implemented via a convolutional neural network (CNN) for efficient processing, as shown for example in FIG. 11. Non-Max Suppression algorithms are applied to associate multiple sub-detections to a single subject—head or body—and the PD assigns a visual descriptor to each event for subsequent tracking. Note that multiple region proposals are usually generated for each head and body over the duration of each visitor's dwell time before each retail camera. Regions are tracked with an ID and associated confidence level to assist with selecting the best representative views at the end of the visit.

Short-Term Tracker (STT). The STT works in batches of body crops that belong to frames from the same camera. Associations are processed over a configurable interval of time.

The STT groups the image crops generated by the PD within the scope of a single camera to associate them to a single visitor based on visual persistence of similar body crop, position and predicted trajectories of an individual moving through the pre-referenced camera space. It outputs a list of tracklets per camera, individual, and time interval.

Day-Term tracker (DTT). The DTT works on longer time windows than the STT, hierarchically grouping tracklets until it finds the optimal solution where all are grouped by a unique person to a threshold of confidence. This procedure integrates tracklets from multiple cameras.

Once the tracklets are grouped by unique IDs, the DTT selects a subset of head and body crops that best describe that visitor. It does so by clustering each person's associated visual descriptors in K groups and gets the centroid of each cluster as a representative crop. In doing so, the DTT reduces the amount of data to be processed on next steps while maximizing useful information.

Tracking Analysis (TA). From the tracking information generated by the DTT, the TA subsystem extracts the following commercially-valuable information for each person identified:
Shop entry time
Shop departure time
Dwell time per camera

The TA also provides functionality to calibrate the in-store cameras and store layout. If that information is set up, the TA module can also extract the following information for each person detected:
2D Heatmap
Long-term tracking
Long dwell at the checkout line

Spear the Video (STV). Complex feature vector development is accomplished in this exemplary implementation by means of a series of deep learning models in the form of multiple CNNs collectively referred to in this embodiment as Spear the Video (STV). The process is driven by the imagery packages provided by the DTT and PD as best representing the visitor in question, with parallel feature-extraction procedures in place to build both the Demographic and Fashion vectors as efficiently as possible. Deep learning is applied at four different tiers of resolution simultaneously—whole-frame, body crop, facial crop, and the product-specific sub crops. Each of these submodules is described below.

Feature extraction based on the full uncropped image capture is shown in FIG. 12. The objective of this processing tier is to estimate each visitor's immediate environment and the activities they may be engaged in. The output would be a list of class labels representing various retail activities and environments along with a weighting indicative the confidence the model has in the conclusion. As such, multiple complementary or conflicting activities may be indicated associated with the same image. Per the example in FIG. 12, the customer may be waiting in line while also talking on their phone.

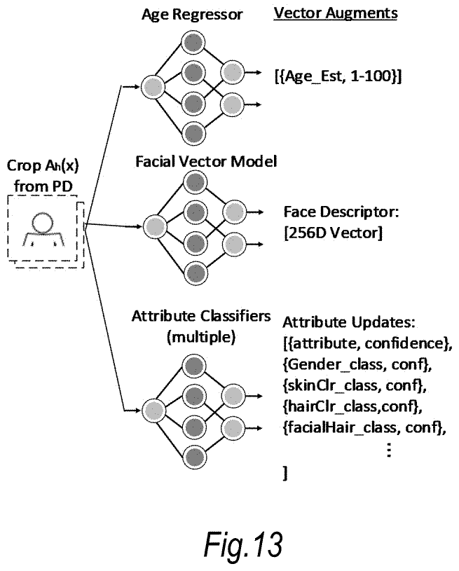

At the second tier, face crops from the PD form the basis for most augments to the Demographic Feature vector. This processing is implemented in the current embodiment using a series of pre-trained CNN's, as shown in FIG. 13. The output consists of a series of visually discernable class label identifiers with an associated weighting. Examples of labels would include age range, gender, skin color, hair color, and facial hair. The STV subsystem performs this demographic feature extraction on multiple person crops associated with each visitor identified by the DTT, which makes the predictions more robust than using a single image.

In addition to age and physical attributes, this exemplary implementation also includes a dedicated CNN to develop a 256-dimension parametric description of the visitor's face, which is then associated to a unique ID referred to as a faceID. While not uniquely-identifying, this faceID and its associated parametric vector can be used as a locally-reliable means of associating repeat visits from the same customer in the absence of other confirming information. When used in concert with the other two parametric descriptions developed by the PMPS—the Body Visual Descriptor and one or more Product Visual Descriptors—forms a sound basis for fine-grain market segment analysis in the fashion market.

Note that the class detail shown in FIG. 13 is for illustrative purposes only. The actual feature vector in JSON format is typically much longer, and will contain details specific to the retail focus of the application.

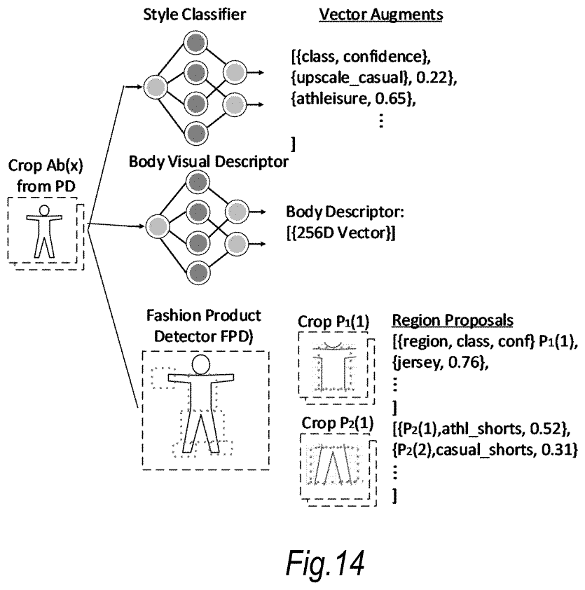

At the third tier, body crops from the PD form the basis for Fashion vector augments, as illustrated in FIG. 14. In this embodiment, multiple CNN's are applied to generate an overall assessment of the desired style aesthetic, along with the development of a 256-element parametric Body Descriptor model that will supplement the Facial Descriptor model derived from the associated head crop. The most highly weighted body crops will also be input into a Fashion Production Detector model utilizing technology analogous to the Person and Face Detectors (PFD) to identify and bound likely fashion products embedded within the body crop. Non-Max Suppression algorithms are applied here as well to associate sub-detections to a single object whenever possible. Upon identification of a given product or products with adequate resolution and confidence, these sub-crops are stored as interim records for further processing.

Note that the class detail shown in FIG. 14 is for illustrative purposes only. The actual feature vector in JSON format is typically much longer and tailored to the focus of the application.

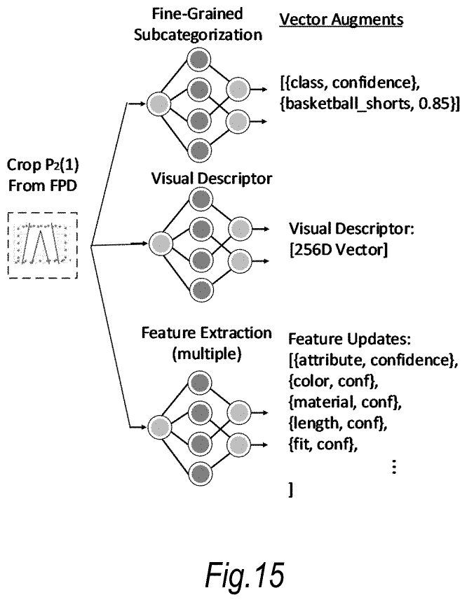

At the deepest level of processing, individual fashion products are subjected to deep learning-based analysis, as illustrated in FIG. 15. This includes a fine-grained CNN classifier to more specifically identify the identified product and one of more CNN's to identify specific attributes such as color, material, cut, etc. These outputs are in the form of a class label with associated confidence weighting as shown. In this implementation, the product crop is also processed by a CNN to create a parametric descriptor model similar in structure to procedures used for the Facial Description and Body Description. These descriptors can then be applied to commercially valuable activities such as finding similar products the customer might be interested in, while avoiding near-duplicates or remarketing the exact product a customer recently bought, which is common in the current state-of-the-art.

The class detail shown in FIG. 15 is for illustrative purposes only. The actual feature vector in JSON format is typically much longer and tailored to the focus of the application.

In one aspect of this embodiment, progressively more detail will be derived based on the fidelity of the imagery obtained. Lower-resolution imagery such as from a legacy security camera might yield demographic information as well as an estimate of the overall style the individual is attempting to convey. Slightly higher resolution such as from modern color security cameras might identify a varying number of fashion products, and high-resolution imagery such as that from a magic-mirror type application could lead to a detailed breakdown of multiple items being worn by the individual. The image processing stages will be tailored by product detection, explained below, to avoid unproductive image analysis.

In another aspect of this embodiment, note that multiple potential label weightings are carried throughout the process vs casting the individual as any single stylistic type. This is especially important in the fashion market, as the identification of multiple products similar to those the individual is wearing or has historically purchased can be used directly by fashion consultants or within a search engine application to advise on other products the customer might be interested in. Engaging the customer in a positive and helpful way is central to this current technology.

A third aspect of this embodiment is that the level of detail can be product- and domain-specific. A shoe retailer, for example, would naturally want to focus on footwear down to the brand and model level to maximize the opportunity for product sales across their inventory. Other clothing items can be assessed at a higher level without the need to train specific Feature and Product Descriptor models related to those fashion items.

A fourth aspect of the current embodiment is that product detection and characterization may be applied to several images provided by the DTT representing the same session. This procedure allows for generalization across multiple models to identify the most products and in the most detail possible.

A fifth aspect of the current embodiment is that the Facial Descriptors and Body Descriptors can be employed with a significant degree of accuracy to associate visits by the same customer to the same location, thereby enable comparisons to how the person's stylistic interests and preferences have likely changed over time. This information is also central to curation of persona groups as outlined below.

A sixth aspect of the current embodiment, all information derived by the PMPS associated with a given visitor and visit is compiled and stored by a uniquely-assigned faceID. The record of the feature vectors with visit-related metadata such as store ID and record start time will be transferred to cloud storage for longer-term analysis. Local imagery related to visitors and the interim crops analyzed by the PMPS will be destroyed at the end of the processing session, a clear advantage over competitive approaches relying on large repositories of persistent reference imagery.

A seventh aspect of the current embodiment, the processing of commercially-valuable information is directly under the purview of the retailer. This readily allows the retailer to extend to the customer the ability to review, correct, or delete the information collected related to their visit, and opt into or out of the process going forward.

Persona-Based Preference Analysis

A persona (also user persona, customer persona, buyer persona) in user-centered design and marketing is a fictional character created to represent a user type that might use a site, brand, or product in a similar way. Marketers may use personas together with market segmentation, where the qualitative personas are constructed to be representative of specific segments. The term persona is used widely in online and technology applications as well as in advertising, where other terms such as pen portraits may also be used.

As discussed in the overview, this exemplary embodiment uses personas rather than uniquely-identifying user accounts to derive economically useful insights from the feature vectors created by the In-Store Video Subsystem via the PMPS. These personas are usually defined based on a clustering of actual profile data derived from the PMPS over time and will likely be enriched to reflect revenue targets for this subset of customers and products likely to appeal to them.

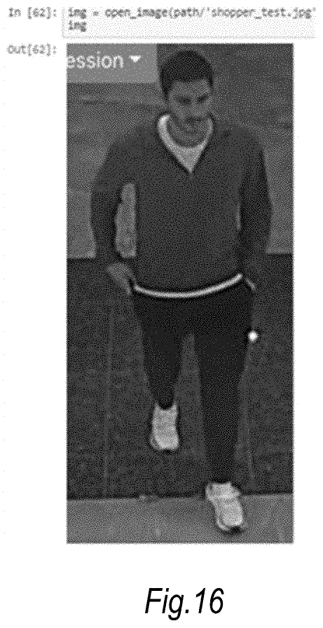

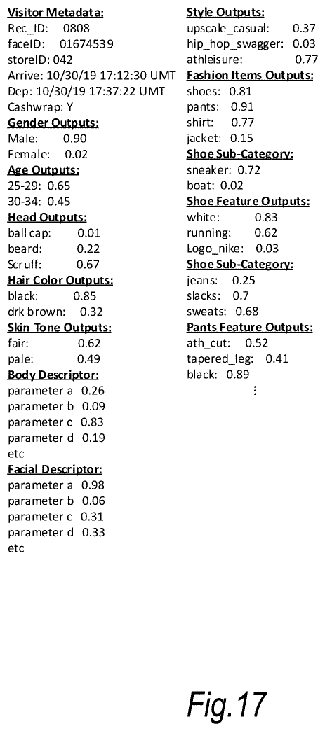

Consider the notional shopper represented in FIG. 16, derived from actual in-store video imagery as the visitor entered a retail store (reproduced with permission). This visit could result in an enhanced feature vector as summarized in FIG. 17. Note that the actual visitation JSON record would actually be substantially longer but this shortened example is provided for ease of illustration.

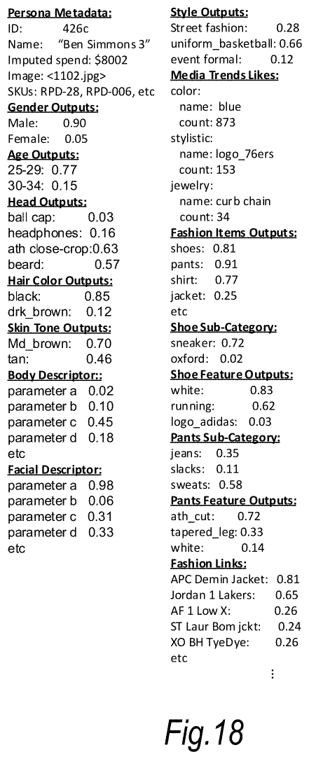

This resulting feature vector will then be scored against a set of pre-defined persona files, as show in FIG. 4. These persona files will have a data schema very similar to the derived customer personas for ease of field-wise comparison, but will actually be more complete and also include additional commercial information. Personas in this implementation are largely based on the merged attributes of actual store visitors aggregated over some period of time and enriched with primary marketing research, but can also include known celebrity influencers or “mannequins” representing emerging fashion trends. One such persona is represented in abbreviated form in FIG. 18, attempting to capture the mid-2019 fashion aesthetic promoted by NBA player Ben Simmons. Note that this feature vector includes significant commercial information including professional affiliations, fashion brands endorsed by Simmons during this time period, fashion items he was seen wearing at events, and even links to in-store products that might appeal to those attracted to Ben Simmons' fashion aesthetic. Note too that actual personas employed by this exemplary implementation would be represented in JSON and would generally encompass thousands of lines of code. This simplified table is provided for purposes of concise illustration.

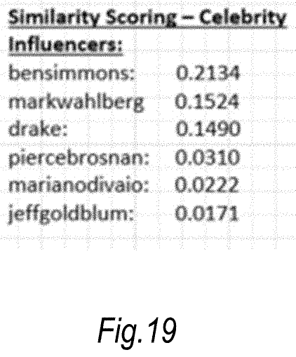

The affinity function utilized in this exemplary embodiment is a cosign distance algorithm at full vector dimensionality, with rule-based preprocessing to compensate for information that may be missing or incomplete. Full agreement among all parameters in the feature vectors being compared would result in an effective similarity “alignment” of 1, analogous to cosine of 0 degrees. The agreement of each member of the vector contributes to a result between 0 and 1, with additional weighting across the full set of personas under evaluation to yield the final similarity score at varying level of dimensionality. Several examples of this similarity scoring between the shopper represented by the vector in FIG. 17 and various celebrity influencer personas reflected in the current embodiment are shown in FIG. 19.

As desired, the resulting output will include a diversity of possible associations, with locally derived personas having the strongest affinity and celebrity influencers included to inject stylistic diversity and fashion trend-following. In this implementation, a vector of all non-zero similarity scores is associated to the visitor's profile, identified by faceID. By referencing the multiple personas with the strongest associations to each visitor, products can be suggested by sales associates or on-line search algorithms that are most likely to appeal to that customer, and also to stimulate period-relevant context for fashion recommendations that might otherwise hinge on the fashion expertise of the individual associate.

Beyond positioning of best-fit individual products for a given customer, this exemplary embodiment allows for macro-level analysis of significant commercial metrics, including:
Dwell time and visitation frequency of various persona groups
Mix of personal groups present as a function of time and relative store profitability
Real-time response of persona and roll-up marketing groups to external marketing efforts with profitability
Seasonal variation of persona groups as a function of store profitability
Mix of persona groups as a leading indicator of store unprofitability or merchandise loss

Machine Learning-Based Persona Management

In this exemplary embodiment, the process of curating the mix of personas relies on a similar cosine distance method as that used for initial matching of customer-derived Feature Vectors to relevant personas. Over the course of a non-real time working interval, a history is maintained of the aggregate relative misalignment between actual observed visitor data and the persona segment representations. The objective of ongoing optimization is to maximize aggregate similarity while simultaneously minimizing similarity variability with a minimum number of economically significant personas. Relatively high error compared to historical precedent is a reliable indicator that the chosen personas need to be modified, while significant periodic variability indicates special causes for additional investigation. As a last resort, performance can be improved by the introduction of additional personas with a resulting increase in computational overhead.

The primary method of persona curation in the present technology is the evaluation of “pseudo personas” based on actual measured feature vectors that are “close” in cosine space alignment to the existing personas. The resulting aggregate error is then recalculated based on historical visitor feature vector repositories over some time period and the resulting error is tracked as if these vectors were in use as commercial personas. In this way “persona migration” can be tracked as a statistical entity and the semi-static personas modified over time to continuously minimize error. If necessary, additional “leaf” personas can be defined to drive a commensurate reduction in aggregate error, variability or both.

Rather than being noise, these migrations in number and quantification of the personas represents extremely valuable marketing information, as the driver is commonly rooted in relevant factors such as changes in customer mix, inventory turn-over, and competitor initiatives. Reduction in the error associated with personas representing new fashion trends, for example, will reliably indicate adoption of that trend within the geographic affinity zone of that store. Changes in personal alignment surrounding certain promotional activities can serve as a statistical measure of that marketing campaign's practical effectiveness. Errors between actual observed persona mix and the assumed profitability inherent to those personas will help to understand relative buying power of the various groups.

In the extreme, this solution does elegantly support “personas of one,” or personas related to very small groups of individuals that may warrant VIP treatment. Even these customers, though, can expect a fundamentally more enriching shopping experience than competing “unique-match” models that primarily exploit purchase history to promote the same products and offer tiered discounts in an often-abrasive attempt to maximize spend.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

We claim:

1. A system comprising:
one or more video cameras for capturing image data; and
one or more computers comprising one or more processors and one or more storage locations, the one or more processors configured to execute software instructions to:
process the image data captured by the one or more video cameras using one or more neural networks to identify people within the image data and traits of the identified people;
generate a feature vector representing a person and his/her demographic traits;
generate a second feature vector highlighting a person's fashion preferences and self-expression;
generate personas based on commonality between different feature vectors;
group an individual newly captured by the one or more video cameras into one or more personas based on his/her feature vectors.

2. The system of claim 1, further comprising the step of refining personas over time based on newly defined feature vectors.

3. The persona curation system of claim 2, where the evolution of persona definitions over time provides marketing insights into changes of customer demographics, stylistic preferences, and fashion trends.

4. The persona curation system of claim 2, where unsupervised learning algorithms are applied to find the optimal fit of the observed data to a set of personas based on some criteria.

5. The persona curation system of claim 2, where personas representing small groups or single individuals can be created by faceID.

6. The system of claim 1, further comprising the step of identifying how closely a newly defined feature vector maps to the one or more personas.

7. The persona matching solution of claim 6, where specific products and historical revenue targets can be associated with persona groups to estimate sales potential and recommend a mix of products.

8. The persona matching solution of claim 6, where the efficient implementation of persona-based filtering enables near real-time development of product recommendations to enhanced interactions between customers and store staff or web site search engines.

9. The persona matching solution of claim 6, where this information can be stored for long-term analysis of store trends without the need to store specific imagery.

10. The persona matching solution of claim 6, where persona alignment can be performed for on-line shoppers using AI-based inspection of viewed imagery enriched by information in the loyalty account.

11. The persona matching solution of claim 6, where use of facial id can be used to estimate repeat visitors.

12. The system of claim 1, further comprising the step of generating a new persona where one or more newly defined feature vectors map to existing personas by less than a predefined threshold.

13. The persona generation solution of claim 12, where celebrities and style influencers can be substituted for real individuals to offer stylistic diversity and trend-following

14. The system of claim 1, the one or more processors further identifying recommendations for a person based on which persona the person maps to and known traits of the persona.

15. The recommendation system of claim 14, where varying levels of imagery resolution and model fidelity can be exploited to make recommendations about products and services that are most relevant to the business.

16. The recommendation system of claim 14, where the association of a given customer to multiple personas provides diversity in product recommendations and consulting.

17. The recommendation system of claim 14, where AI-based detection of specific fashion items worn by the customer enables product suggestions that build on the customers current style without repetition.
